(19) United States
(12) Patent Application Publication
(10) Pub. No.: US 2026/0243599 A1
(43) Pub. Date: Aug. 20, 2026

(54) IMAGE SENSOR AND OPERATING METHOD THEREOF

(71) Applicant: SAMSUNG ELECTRONICS CO., LTD., Suwon-si (KR)

(72) Inventors: Yeongseok SHIM, Suwon-si (KR); MINWOONG SEO, Suwon-si (KR); Sanggwon LEE, Suwon-si (KR)

(73) Assignee: SAMSUNG ELECTRONICS CO., LTD., Suwon-si (KR)

(21) Appl. No.: 19/326,206

(22) Filed: Sep. 11, 2025

(30) Foreign Application Priority Data
Feb. 17, 2025 (KR) 10-2025-0020164

(51) Int. Cl. G01J 1/44; H04N 25/51; H04N 25/59; H04N 25/78

(52) U.S. Cl. CPC G01J 1/44; H04N 25/51; H04N 25/59; H04N 25/78; G01J 2001/446; G01J 2001/448

(57) ABSTRACT

An image sensor includes a pixel including a photodiode accumulating charges based on light, a first transfer transistor connected between the photodiode and a first floating diffusion node, and operating based on a first transfer signal, a second transfer transistor connected between the photodiode and a second floating diffusion node, and operating based on a second transfer signal, a dual conversion transistor connected between the first floating diffusion node and the second floating diffusion node, and operating based on a dual conversion signal, a reset transistor connected between a first power terminal and the second floating diffusion node, and operating based on a reset signal, a drive transistor connected between a second power terminal and a first node, and operating based on a first floating diffusion node voltage, and a select transistor connected between the first node and a column line, and operating based on a selection signal.

### CROSS-REFERENCE TO RELATED APPLICATIONS

This application is based on and claims priority under 35 U.S.C. § 119 to Korean Patent Application No. 10-2025-0020164 filed on February 17, 2025, in the Korean Intellectual Property Office, the disclosures of which are incorporated by reference herein in their entireties.

### BACKGROUND

An image sensor converts light received through a photodiode into an electrical signal. For example, the image sensor converts an optical signal corresponding to light reflected from an external object into the electrical signal, thereby obtaining image data for the external object. An electronic device including the image sensor may display an image on a display panel by using the obtained image data.

Meanwhile, in order to implement a high dynamic range (HDR), the image sensor may obtain the image data by performing a readout operation through a dual conversion gain mode. A method for improving performance of the image sensor supporting the dual conversion gain mode is proposed.

### SUMMARY

Embodiments of the disclosure provide an image sensor including a pixel that supports a dual conversion gain mode.

According to an aspect of the disclosure, there is provided an image sensor including: a pixel, wherein the pixel includes: a photodiode configured to accumulate charges based on an optical signal, a first transfer transistor connected between the photodiode and a first floating diffusion node, the first transfer transistor configured to operate based on a first transfer signal, a second transfer transistor connected between the photodiode and a second floating diffusion node, the second transfer transistor configured to operate based on a second transfer signal, a dual conversion transistor connected between the first floating diffusion node and the second floating diffusion node, the dual conversion transistor configured to operate based on a dual conversion signal, a reset transistor connected between a first power terminal and the second floating diffusion node, the reset transistor configured to operate based on a reset signal, a drive transistor connected between a second power terminal and a first node, the drive transistor configured to operate based on a voltage of the first floating diffusion node, and a select transistor connected between the first node and a column line, the select transistor configured to operate based on a selection signal.

According to another aspect of the disclosure, there is provided an image sensor including: a pixel including: a first transfer transistor, a second transfer transistor, and a photodiode configured to accumulate charges based on an optical signal, wherein, based on the pixel operating in a high conversion gain mode: the first transfer transistor is configured to transfer partial charges of the charges accumulated in the photodiode to a first floating diffusion node, and the second transfer transistor is configured to transfer at least a part of remaining charges of the charges accumulated in the photodiode to a second floating diffusion node, and wherein a first readout operation is performed corresponding to the partial charges transferred to the first floating diffusion node; and wherein the pixel is configured to enter a low conversion gain mode after the first readout operation.

According to another aspect of the disclosure, there is provided an image sensor including a pixel array including a plurality of pixels, a timing controller configured to generate control signal, and a row decoder configured to generate, based on the control signal, at least one of a first transfer signal, a second transfer signal, a dual conversion signal, a reset signal, and a selection signal to drive the pixel array. Each of the plurality of pixels may include a photodiode configured to accumulate charges based on an optical signal, a first transfer transistor connected between the photodiode and a first floating diffusion node, the first transfer transistor configured to operate based on a first transfer signal, a second transfer transistor connected between the photodiode and a second floating diffusion node, the second transfer transistor configured to operate based on a second transfer signal, a dual conversion transistor connected between the first floating diffusion node and the second floating diffusion node, the dual conversion transistor configured to operate based on a dual conversion signal, a reset transistor connected between a first power terminal and the second floating diffusion node, the reset transistor configured to operate based on a reset signal, a drive transistor connected between a second power terminal and a first node, the drive transistor configured to operate based on a voltage of the first floating diffusion node, and a select transistor connected between the first node and a column line, the select transistor configured to operate based on a selection signal.

### BRIEF DESCRIPTION OF THE FIGURES

The above and other objects and features of the disclosure will become apparent by describing in detail embodiments thereof with reference to the accompanying drawings.

FIG. 1 is a block diagram illustrating an image processing system, according to an embodiment of the disclosure.

FIGS. 2A and 2B are block diagrams illustrating an image sensor, according to an embodiment of the disclosure.

FIG. 3 is a circuit diagram illustrating a pixel, according to an embodiment of the disclosure.

FIG. 4 is a timing diagram for describing an example of an operation of an image sensor, according to an embodiment of the disclosure.

FIG. 5 is a circuit diagram illustrating a pixel, according to an embodiment of the disclosure.

FIG. 6 is a timing diagram for describing an example of an operation of an image sensor, according to an embodiment of the disclosure.

FIGS. 7A to 7E are diagrams conceptually describing an operation of a pixel, according to an embodiment of the disclosure.

FIGS. 8A and 8B are diagrams conceptually describing an operation of a pixel, according to an embodiment of the disclosure.

FIG. 9 is a flowchart illustrating an example of an operation of an image sensor, according to an embodiment of the disclosure.

FIG. 10 is a circuit diagram illustrating a pixel, according to an embodiment of the disclosure.

FIG. 11 is a block diagram of an electronic device including a multi-camera module.

FIG. 12 is a block diagram illustrating a camera module of FIG. 11 in detail.

### DETAILED DESCRIPTION

Hereinafter, embodiments of the disclosure will be described clearly and in detail such that those skilled in the art may easily carry out the disclosure.

Components described with reference to the terms used in the detailed description or the claims and the functional blocks illustrated in drawings may be implemented with software, hardware, or a combination thereof. For example, the software may be a machine code, firmware, an embedded code, and application software. For example, the hardware may include, but is not limited to, an electrical circuit, an electronic circuit, an electrical component, a processor, a memory, a computer, an integrated circuit, integrated circuit cores, a pressure sensor, an inertial sensor, a passive element, or a combination thereof.

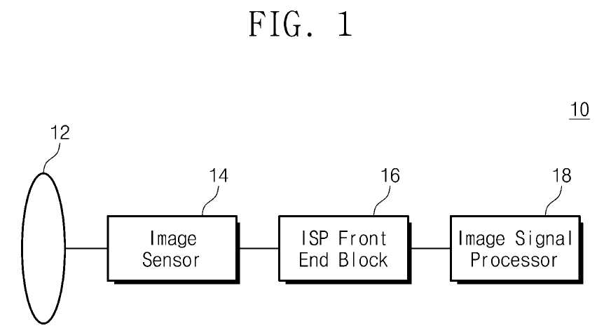

FIG. 1 is a block diagram illustrating an image processing system, according to an embodiment of the disclosure. Referring to FIG. 1, an image processing system 10 may include a lens 12, an image sensor 14, an image signal processor (ISP) front end block 16, and an image signal processor 18. However, the disclosure is not limited thereto, and as such, according to an embodiment, the image processing system 10 may include one or more additional elements. The image processing system 10 may be implemented as a part of various electronic devices such as a smartphone, a digital camera, a laptop, a desktop.

Light may be reflected by an object, a landscape, etc., to be photographed, and the lens 12 may receive the reflected light. The image sensor 14 may generate an electrical signal based on light (or an optical signal) received through the lens 12. For example, the image sensor 14 may be implemented as a complementary metal oxide semiconductor (CMOS) image sensor etc. For example, the image sensor 14 may be a multi-pixel image sensor having a dual pixel structure or a tetracell structure.

The image sensor 14 may include a pixel array. The pixel array may include pixels, which convert light into electrical signal. For example, the pixels may generate pixel signals (e.g., the electrical signal) by converting the light. A ratio at which light is converted into the electrical signal (e.g., a voltage) may be defined as a conversion gain. For example, the pixel array may generate a pixel signal in a low conversion gain mode (hereinafter referred to as a “LCG mode”) and a high conversion gain mode (hereinafter referred to as a “HCG mode”), using a dual conversion gain (DCG) that changes the conversion gain.

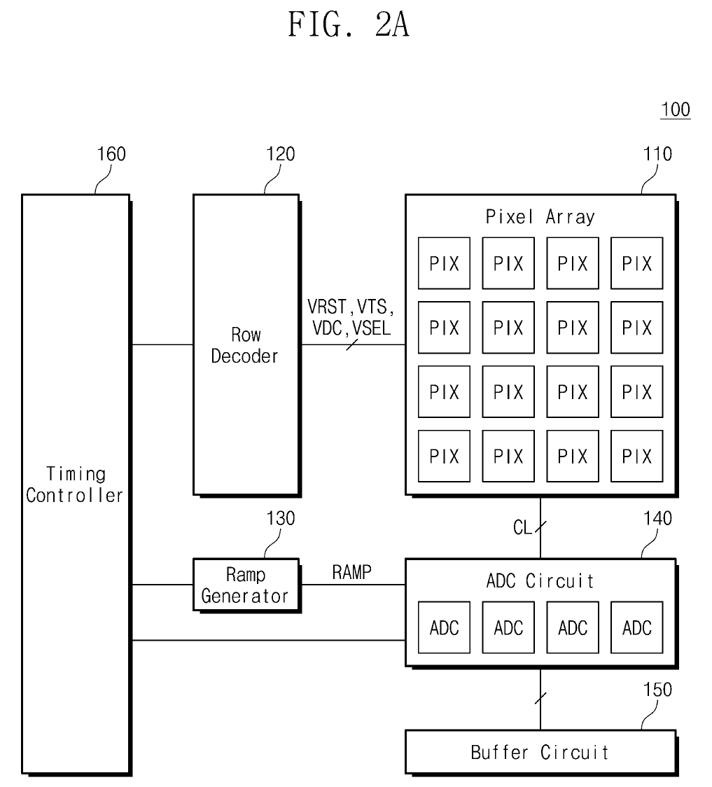

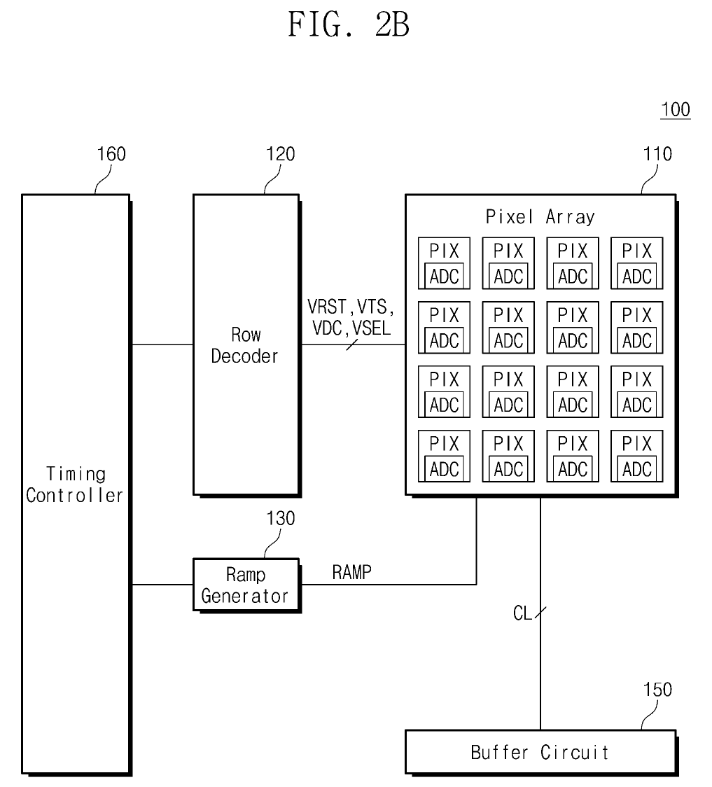

According to an embodiment, the image sensor 14 may include an analog-to-digital converting circuit (hereinafter referred to as a “ADC Circuit”) for performing correlation double sampling (CDS) on the pixel signals. The configuration of the image sensor 14 is described in more detail with reference to FIGS. 2A and 2B.

According to an embodiment, the ISP front end block 16 may perform pre-processing with respect to the electrical signal output from the image sensor 14 so as to be appropriate for processing of the image signal processor 18. For example, the ISP front end block 16 may perform pre-processing on the electrical signal output from the image sensor 14 and input the pre-processed electrical signal to the image signal processor 18.

According to an embodiment, the image signal processor 18 may generate image data associated with the photographed object, scenery, etc., by appropriately processing the electrical signal processed by the ISP front end block 16. To this end, the image signal processor 18 may perform various processes such as color correction, auto white balance, gamma correction, color saturation correction, bad pixel correction, and hue correction.

While the image processing system 10 of FIG. 1 is illustrated to include one lens 12 and one image sensor 14, this is an example, and the scope of the disclosure is not limited thereto. For example, the image processing system 10 may include a plurality of lenses, a plurality of image sensors, and a plurality of ISP front end blocks. In this case, the plurality of lenses may have fields of view different from each other. Further, each of the plurality of image sensors may have different functions, different performances, and/or different characteristics, and may include pixel arrays of different configurations.

FIGS. 2A and 2B are block diagrams illustrating an image sensor, according to an embodiment of the disclosure. Referring to FIGS. 1 and 2A, the image sensor 100 may include a pixel array 110, a row decoder 120, a ramp generator 130, an ADC circuit 140, a buffer circuit 150, and a timing controller 160.

The pixel array 110 may include a plurality of pixels PIXs, and may be in the form of a matrix including a plurality of pixel rows and a plurality of pixel columns. In other words, each of the plurality of pixels PIXs may be arranged in a row direction and a column direction. Pixels PIXs located in a same column may be connected to a same column line CL. Pixels PIXs located in a same row may be connected to a same reset line.

Each of the plurality of pixels PIXs of the pixel array 110 may include a photoelectric conversion element. For example, the photoelectric conversion element may include a photodiode, a phototransistor, a photogate, a pinned photodiode, etc. Each of the plurality of pixels PIXs may detect the light by using the photoelectric conversion element and convert the optical signal corresponding to the detected light into the electrical signal (e.g., the pixel signal). For example, each of the plurality of pixels PIXs may output the pixel signal according to the intensity of light or amount of light received from outside. In this case, the pixel signal may be an analog signal corresponding to the intensity of light or amount of light received from the outside.

While the pixel array 110 of FIG. 2A is illustrated to include four rows and four columns (i.e., 4×4) of pixels PIXs, this is an example, and the scope of the disclosure is not limited thereto, and the number of the plurality of pixels PIXs may be less or more than that of the above, and the arrangement structure may be different from the above.

As described above, the pixel PIX according to an embodiment of the disclosure may support a dual conversion gain mode. Accordingly, the pixel PIX may operate in the HCG mode or the LCG mode.

The plurality of pixels PIXs may generate the pixel signals based on various signals received from the row decoder 120, and output the generated pixel signals through the plurality of column lines CLs. The various signals may include, but is not limited to, control signals such as a transfer signal VTS, a reset signal VRST, a dual conversion signal VDC, or a selection signal VSEL. For example, each of the plurality of pixels PIXs may output an HCG pixel signal in the HCG mode and output an LCG pixel signal in the LCG mode.

The row decoder 120 may select and drive the row of the pixel array 110. For example, the row decoder 120 may decode an address and/or a control signal generated by the timing controller 160 to generate the control signals (e.g., the transfer signal VTS, the reset signal VRST, the dual conversion signal VDC, the selection signal VSEL, etc.,) for selecting and driving the row of the pixel array 110.

The ramp generator 130 may generate a ramp signal RAMP. The ramp generator 130 may operate under the control of the timing controller 160. For example, the ramp generator 130 may operate in response to the control signal, such as a ramp enable signal, a mode signal, etc. In an example case in which the ramp enable signal is activated, the ramp generator 130 may generate the ramp signal RAMP according to a reference value. For example, when the ramp enable signal is activated, the ramp generator 130 may generate the ramp signal RAMP according to the reference value. The reference value may be a predetermined value. For example, the predetermined value may include, but is not limited to, a start level, an end level, a slope, etc. That is, the ramp signal RAMP may be a signal that increases or decreases according to a predetermined slope during a specific time. The ramp signal RAMP may be provided to the ADC circuit 140.

The ADC circuit 140 may receive the pixel signals from the plurality of pixels PIXs of the pixel array 110 through the column lines CLs, and may receive the ramp signal RAMP from the ramp generator 130. The ADC circuit 140 may perform analog-digital conversion on the pixel signals. For example, the ADC circuit 140 converts the pixel signals (which are analog signals) output from the pixel array 110 into digital signals. The ADC circuit 140 may include a plurality of ADCs. For example, each of the plurality of ADCs may operate based on the correlation double sampling (CDS) technique that obtains a reset level and a signal level for the pixel signal received from the corresponding pixel PIX and extracts difference as a valid signal component.

For example, each of the plurality of ADCs may include a comparator and a counter. The comparator may compare the pixel signal output by the corresponding pixel PIX through the column line CL with the ramp signal RAMP, and output a comparison result. The counter may count pulses of a signal on which the correlation double sampling (CDS) has been performed, output by the corresponding comparator and output the counted pulses as the digital signal.

For example, the ADC circuit 140 may perform analog-digital conversion by comparing an HCG reset level and an HCG signal level for the HCG pixel signal, and an LCG reset level and a LCG signal level for the LCG pixel signal output by each of the plurality of pixels PIXs with the ramp signal RAMP level.

The buffer circuit 150 may store the digital signal output from the ADC circuit 140. The buffer circuit 150 may detect and amplify the stored digital signal. The buffer circuit 150 may output the amplified digital signal as image data. For example, the buffer circuit 150 may transfer the image data to the ISP front end block 16 (as shown in FIG. 1).

As described above, each of the plurality of pixels PIXs included in the pixel array 110 of the image sensor 100 may include the photoelectric conversion element and support the dual conversion gain mode. The image sensor 100 according to an embodiment of the disclosure may perform a readout operation in each of the HCG mode and the LCG mode. For example, each of the plurality of pixels PIXs may include two or more floating diffusion nodes.

For example, each of the plurality of pixels PIXs may include a first floating diffusion node and a second floating diffusion node. For example, in the HCG mode, the first floating diffusion node and the second floating diffusion node may not be electrically connected. For example, in the LCG mode, the first floating diffusion node and the second floating diffusion node may be electrically connected. In this case, in the LCG mode, the first floating diffusion node and the second floating diffusion node are electrically connected, so that an extended floating diffusion node may be generated.

The photoelectric conversion element can accumulate charges based on the optical signal. The pixel may transfer a partial charges of the charges accumulated in the photoelectric conversion element to the first floating diffusion node. In addition, the pixel may transfer a remaining charges of the charges accumulated in the photoelectric conversion element to the second floating diffusion node.

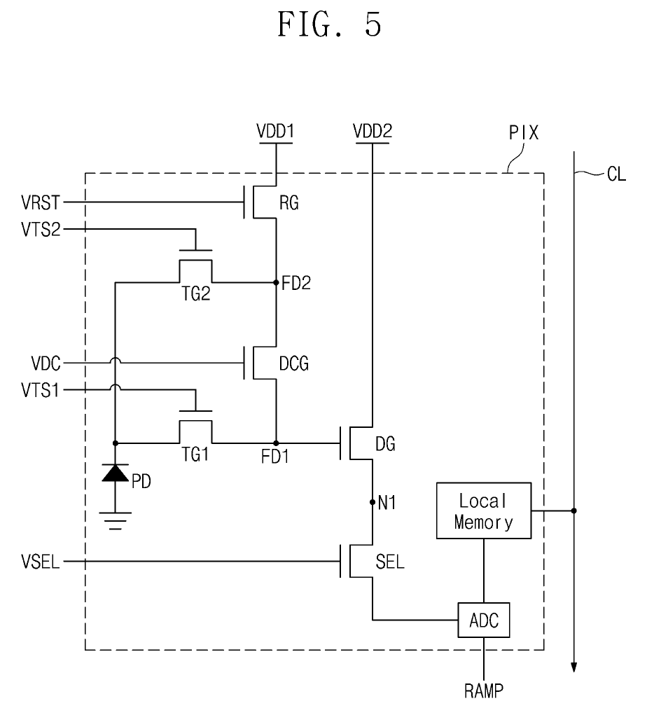

The image sensor 100 may perform a first readout operation (or HCG readout operation) for the first floating diffusion node in the HCG mode, and perform a second readout operation (or LCG readout operation) for the extended floating diffusion node in the LCG mode. Here, before the image sensor 100 performs the first readout operation and the second readout operation, the image sensor 100 may perform an operation of transferring the partial charges and the remaining charges to the first floating diffusion node and the second floating diffusion node, respectively. The configuration of the pixel and the operation of the image sensor 100 are described in detail below with reference to FIGS. 5 to 8B.

Referring to FIGS. 1 and 2B, the image sensor 100 may include a pixel array 110, a row decoder 120, a ramp generator 130, a buffer circuit 150, and a timing controller 160. Unlike the image sensor 100 of FIG. 2A, the image sensor 100 of FIG. 2B may not include a separate ADC circuit 140, and each of the plurality of pixels PIXs may include an internal ADC. That is, the image sensor 100 of FIG. 2B may be an image sensor 100 including the pixel array 110 implemented based on a pixel-level ADC structure. In the following, redundant descriptions of configurations of the image sensor 100 of FIG. 2B that are configured to be the same as, and operate the same as, that of the image sensor of FIG. 2A is omitted.

Each of the plurality of pixels PIXs may include the internal ADC. Each of the plurality of pixels PIXs may generate the pixel signal based on the optical signal detected by the photoelectric conversion element. The generated pixel signal may be converted into the digital signal by the internal ADC. For example, while the pixel signal is output to the ADC circuit 140 through the column line CL in the image sensor 100 of FIG. 2A, the pixel signal may be converted into the digital signal by the internal ADC inside the pixel before being output through the column line CL in the image sensor 100 of FIG. 2B.

For example, each of the plurality of pixels PIXs may further include a local memory. The digital signal converted by the internal ADC may be stored in the local memory. The image sensor 100 may transfer the digital signal stored in the local memory included in each of the plurality of pixels PIXs to the buffer circuit 150 through the column line CL.

The ramp generator 130 may provide the ramp signal RAMP to the pixel array 110 under the control of the timing controller 160. For example, the ramp generator 130 may transfer the ramp signal RAMP to each of the plurality of pixels PIXs of the pixel array 110. The internal ADC of each of the plurality of pixels PIXs may convert the pixel signal into the digital signal based on the ramp signal RAMP received from the ramp generator 130.

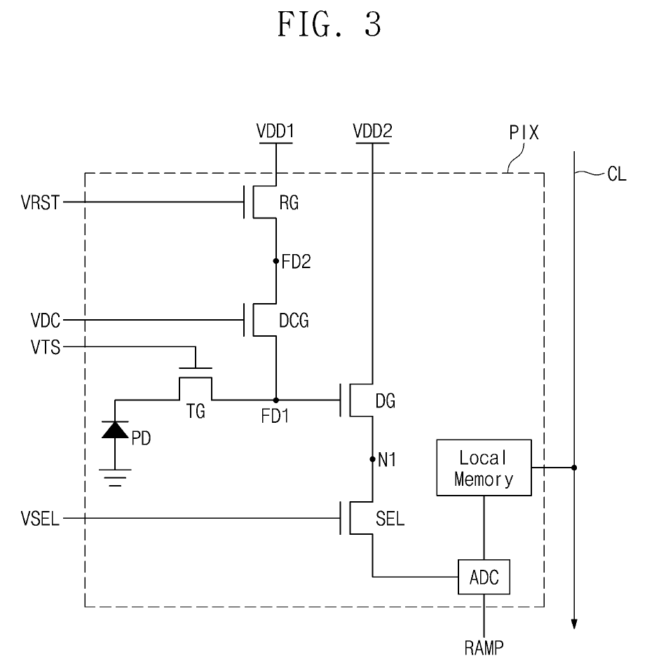

FIG. 3 is a circuit diagram illustrating a pixel, according to an embodiment of the disclosure. Referring to FIG. 3, the pixel PIX may include a photodiode PD, a transfer transistor TG, a dual conversion gain transistor DCG, a reset transistor RG, a drive transistor DG, a selection transistor SEL, an internal ADC, and a local memory.

The transfer transistor TG may be connected between the photodiode PD and the first floating diffusion node FD1 and may include a gate electrode that receives the transfer signal VTS.

The dual conversion gain transistor DCG may be connected between the first floating diffusion node FD1 and the second floating diffusion node FD2, and may include a gate electrode that receives the dual conversion signal VDC.

The reset transistor RG may be connected between a first power terminal and the second floating diffusion node FD2 and may include a gate electrode that receives the reset signal VRST. Here, the first power terminal may receive the first power voltage VDD1.

The drive transistor DG may be connected between a second power terminal and a first node N1 and may include a gate electrode connected to the first floating diffusion node FD1. Here, the second power terminal may receive the second power voltage VDD2.

The selection transistor SEL may be connected between the first node N1 and the internal ADC and may include a gate electrode that receives the selection signal VSEL.

The photodiode PD may accumulate charges based on the optical signal incident from outside. For example, the photodiode PD may generate the charges corresponding to the intensity of light incident on the photodiode PD from the outside and accumulate the generated charges.

The transfer transistor TG may operate based on the transfer signal VTS, the dual conversion gain transistor DCG may operate based on a dual conversion signal VDC, the reset transistor RG may operate based on a reset signal VRST, the drive transistor DG may operate based on a voltage of the first floating diffusion node FD1, and the selection transistor SEL may operate based on a selection signal VSEL.

In an example case in which the dual conversion gain transistor DCG is turned off, the first floating diffusion node FD1 and the second floating diffusion node F D2 may not be electrically connected. In an example case in which the dual conversion gain transistor DCG is turned on, the first floating diffusion node FD1 and the second floating diffusion node FD2 may be electrically connected. In the disclosure, the first floating diffusion node FD1 and the second floating diffusion node FD2 that are electrically connected as the dual conversion gain transistor DCG being turned on, are referred to as an extended floating diffusion node. The extended floating diffusion node may also be referred to as an expanded floating diffusion node.

In an example case in which the dual conversion gain transistor DCG is turned off, the pixel PIX may operate in the HCG mode. In an example case in which the dual conversion gain transistor DCG is turned on, the pixel PIX may operate in the LCG mode. For example, the pixel PIX may operate in the LCG mode after operating in the HCG mode.

According to an embodiment, the pixel PIX may transfer the partial charges of the charges accumulated in the photodiode PD to the first floating diffusion node FD1 in the HCG mode, and may perform the first readout operation on the partial charges transferred to the first floating diffusion node FD1.

According to an embodiment, the pixel PIX may transfer the remaining charges of the charges accumulated in the photodiode PD to the extended floating diffusion node in the LCG mode, and may perform the second readout operation on the remaining charges transferred to the extended floating diffusion node. For example, after performing the first readout operation, the pixel PIX may transfer the remaining charges of the charges accumulated in the photodiode PD to the extended floating diffusion node in the LCG mode, and may perform the second readout operation on the remaining charges transferred to the extended floating diffusion node.

In FIG. 3, while the pixel PIX is shown to be implemented based on a pixel-level ADC structure, such as a plurality of pixels included in the pixel array 110 of the image sensor 100 of FIG. 2B, this is an example, and the scope of the disclosure is not limited thereto. For example, the pixel PIX may be implemented as a plurality of pixels included in the pixel array 110 of the image sensor 100 of FIG. 2A.

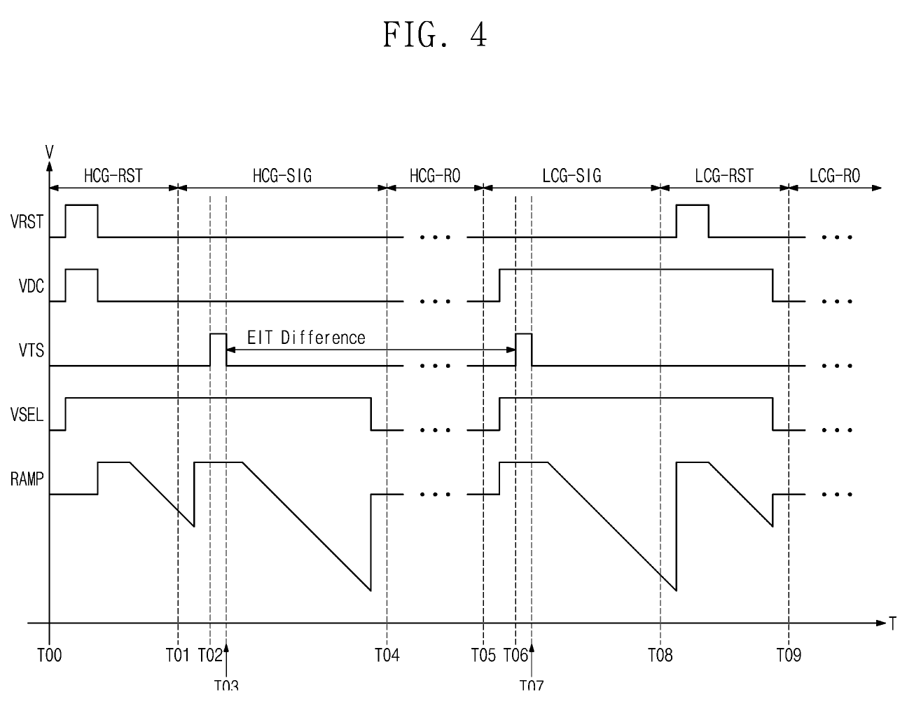

FIG. 4 is a timing diagram for describing an example of an operation of an image sensor according to an embodiment of the disclosure. Referring to FIGS. 3 and 4, levels of the reset signal VRST, the dual conversion signal VDC, the transfer signal VTS, the selection signal VSEL, and the ramp signal RAMP according to time are exemplarily illustrated. In the timing diagram of FIG. 4, the horizontal axis represents time ‘T’, and the vertical axis represents voltage level ‘V’.

In a period between a zeroth time point T00 and a fifth time point T05, the image sensor 100 may operate in the HCG mode, and in a period after the fifth time point T05, the image sensor 100 may operate in the LCG mode. The image sensor 100 may sample the HCG pixel signal in the period between the zeroth time point T00 and a fourth time point T04, and the image sensor 100 may perform the first readout operation in a period between the fourth time point T04 and the fifth time point T05. In a period between the fifth time point T05 and a ninth time point T09, the image sensor 100 may sample the LCG pixel signal, and in a period after the ninth time pointT09, the image sensor 100 may perform the second readout operation.

In a period between a second time point T02 and a third time point T03, the transfer signal VTS may be a logical HIGH level. In the period between the second time point T02 and the third time point T03, the transfer transistor TG may be turned on, and the transfer transistor TG may transfer the partial charges of the charges accumulated in the photodiode PD to the first floating diffusion node FD1.

In a period between the fourth time point T04 and the fifth time point T05, the image sensor 100 may perform the first readout operation corresponding to the partial charges transferred to the first floating diffusion node FD1.

In a period between a sixth time point T06 and a seventh time point T07, both the transfer signal VTS and the dual conversion signal VDC may be a logical HIGH level. In the period between the sixth time point T06 and the seventh time point T07, both the transfer transistor TG and the dual conversion gain transistor DCG may be turned on, and the transfer transistor TG may transfer the remaining charges of the charges accumulated in the photodiode PD to the extended floating diffusion node.

In the period after the ninth time point T09, the image sensor 100 may perform the second readout operation corresponding to the remaining charges transferred to the extended floating diffusion node.

According to an embodiment, a time period during which the image sensor 100 performs sampling may be shorter than a time period during which the image sensor 100 performs the readout operation. For example, the time it takes for the image sensor 100 to sample the pixel signal in the period between the zeroth time point T00 and the fourth time point T04 and the period between the fifth time point T05 and the ninth time point T09 may be shorter than the time it takes for the image sensor 100 to perform the readout operation on the pixel signal in the period between the fourth time point T04 and the fifth time point T05 and the period after the ninth time point T09.

According to an embodiment of the disclosure, in the image sensor 100, a long time period (e.g., a period between the third time point T03 and the sixth time point T06) including a time period during which the image sensor 100 performs the first readout operation may exist during the period between the second time point T02 and the third time pointT03 and the period between the sixth time point T06 and the seventh time point T07. That is, there may be a difference in exposure integration time (EIT) between the period between the second time point T02 and the third time point T03 and the period between the sixth time point T06 and the seventh time point T07.

For example, the photodiode PD may receive more light from the outside from after the image sensor 100 transfers the partial charges corresponding to the HCG pixel signal from the photodiode PD to the first floating diffusion node FD1 to before the image sensor 100 transfers the remaining charges corresponding to the LCG pixel signal from the photodiode PD to the extended floating diffusion node (e.g., in the period between the third time point T03 and the sixth time point T06). Accordingly, the photodiode PD may additionally accumulate charges corresponding to the light received in the period between the third time point T03 and the sixth time point T06.

Accordingly, the remaining charges transferred from the photodiode PD to the extended floating diffusion node in the period between the sixth time point T06 and the seventh time point T07 may include the charges additionally accumulated in the photodiode PD in the period between the third time point T03 and the sixth time point T06. In this case, there is a problem in that additional accumulated charges included in the remaining charges generate noise in the image data. For example, there is a problem in that a ghost image component is included in the image data due to the additional accumulated charges included in the remaining charges.

In FIG. 4, the period during which the image sensor 100 samples the HCG pixel signal may include an HCG-reset period HCG-RST and an HCG-signal period HCG-SIG. The period during which the image sensor 100 samples the LCG pixel signal may include an LCG-signal period LCG-SIG and an LCG-reset period LCG-RST. For example, the period during which the HCG pixel signal is sampled may be configured with the HCG-reset period HCG-RST and the HCG signal period HCG-SIG sequentially. For example, the period during which the LCG pixel signal is sampled may be configured with the LCG-signal period LCG-SIG and the LCG-reset period LCG-RST sequentially. That is, the image sensor 100 may perform RSSR (Reset-Sig-Sig-Reset) sampling.

However, the order of the HCG-reset period HCG-RST, the HCG signal period HCG-SIG, the LCG signal period LCG-SIG, and the LCG-reset period LCG-RST illustrated in FIG. 4 is an example, and the scope of the disclosure is not limited thereto. For example, the image sensor 100 may be configured to perform RSRS sampling, RRSS sampling, etc.

FIG. 5 is a circuit diagram illustrating a pixel according to an embodiment of the disclosure. Referring to FIGS. 2A, 2B, and 5, the pixel PIX may include a photodiode PD, a first transfer transistor TG1, a second transfer transistor TG2, a dual conversion gain transistor DCG, a reset transistor RG, a drive transistor DG, a selection transistor SEL, an internal ADC, and a local memory. The pixel PIX of FIG. 5 may further include the second transfer transistor TG2 compared to the pixel PIX of FIG. 3. The transfer transistor TG of the pixel PIX of FIG. 3 may correspond to the first transfer transistor TG1 of the pixel PIX of FIG. 5.

The second transfer transistor TG2 may be connected between the photodiode PD and the second floating diffusion node FD2 and may include a gate electrode that receives a second transfer signal VTS2. The second transfer transistor TG2 may operate based on the second transfer signal VTS2. The first transfer transistor TG1, the dual conversion gain transistor DCG, the reset transistor RG, the drive transistor DG, and the selection transistor SEL are configured to be the same as described above with reference to FIG. 3, and thus redundant descriptions thereof are omitted.

According to an embodiment, in the pixel PIX of FIG. 5 (as in the pixel PIX of FIG. 3), when the dual conversion gain transistor DCG is turned off, the first floating diffusion node FD1 and the second floating diffusion node FD2 may not be electrically connected, and when the dual conversion diode DC is turned on, the first floating diffusion node FD1 and the second floating diffusion nodeFD2 may be electrically connected, to become an extended floating diffusion node.

Also, in an example case in which the dual conversion gain transistor DCG is turned off, the pixel PIX may operate in the HCG mode. In an example case in which the dual conversion gain transistor DCG is turned on, the pixel PIX may operate in the LCG mode. For example, the pixel PIX may operate in the LCG mode after operating in the HCG mode.

The first transfer transistor TG1 may transfer the partial charges of the charges accumulated in the photodiode PD to the first floating diffusion node FD1, and the second transfer transistor TG2 may transfer the remaining charges except for the partial charges transferred to the first floating diffusion node FD1 to the second floating diffusion node FD2.

The first floating diffusion node FD1 may have first capacitance and the second floating diffusion node FD2 may have second capacitance. The first capacitance may be a capacitance due to a parasitic capacitor of the first floating diffusion node FD1, and the second capacitance may be a capacitance due to a parasitic capacitor of the second floating diffusion node FD2. However, the scope of the disclosure is not limited thereto, a separate physical MIM (Metal Insulator Metal) capacitors or a DRAM capacitor may be connected to the floating diffusion nodes FD1, FD2.

During the time when the first transfer transistor TG1 is turned on by the first transfer signal VTS1 received from the row decoder 120, the charges provided from the photodiode PD may be accumulated in the first floating diffusion node FD1. In addition, during the time when the second transfer transistor TG2 is turned on by the second transfer signal VTS2 received from the row decoder 120, the charges provided from the photodiode PD may be accumulated in the second floating diffusion node FD2. Accordingly, voltage potentials corresponding to charges respectively accumulated in the first floating diffusion node FD1 and the second floating diffusion node FD2 may be formed.

In an example case in which the light intensity is strong, the capacitance of the first floating diffusion node FD1 may not be sufficient to accommodate all the charges accumulated in the photodiode PD. For example, the light intensity may be considered as strong when the light intensity is above a reference value. In this case, since the first floating diffusion node FD1 is easily saturated, the image data of an image to be photographed may not be properly generated. Accordingly, in order to prevent the saturation, the second floating diffusion node FD2 may be used. That is, among the charges accumulated in the photodiode PD, the remaining charges except for the partial charges corresponding to the capacitance of the first floating diffusion node FD1 may be accumulated in the second floating diffusion node FD2.

In another example case in which the light intensity is strong, the sum of the capacitance of the first floating diffusion node FD1 and the capacitance of the second floating diffusion node FD2 may not be sufficient to accommodate all the charges accumulated in the photodiode PD. Accordingly, a part (or at least a part) of the remaining charges except for the partial charges corresponding to the capacitance of the first floating diffusion node FD1 of the charges accumulated in the photodiode PD may be accumulated in the second floating diffusion node FD2. Hereinafter, the sum of the capacitance of the first floating diffusion node FD1 and the capacitance of the second floating diffusion node FD2 will be described assuming that it is sufficient to accommodate all the charges accumulated in the photodiode PD, but the scope of the disclosure is not limited thereto.

In an example case in which the light intensity is weak, the capacitance of the first floating diffusion node FD1 may be sufficient to accommodate all the charges accumulated in the photodiode PD. For example, the light intensity may be considered as weak when the light intensity is below a reference value. Accordingly, all the charges accumulated in the photodiode PD may be accumulated in the first floating diffusion node FD1, and there may be no charges accumulated in the second floating diffusion node FD2.

According to an embodiment, in the HCG mode, the pixel PIX may transfer the partial charges of the charges accumulated in the photodiode PD to the first floating diffusion node FD1, may transfer the remaining charges of the charges accumulated in the photodiodes PD to the second floating diffusion node FD2, and may perform the first readout operation on the partial charges transferred to the first floating diffusion node FD1. According to an embodiment, in the LCG mode, the pixel PIX may perform the second readout operation on the partial charges and the remaining charges shared to the extended floating diffusion node. For example, after performing the first readout operation, the pixel PIX may perform the second readout operation on the partial charges and the remaining charges shared to the extended floating diffusion node in the LCG mode.

According to an embodiment, before performing the first readout operation in the HCG mode, the pixel PIX may sequentially perform an operation of accumulating charges through the first transfer transistor TG1 and the second transfer transistor TG2 in the first floating diffusion node FD1 and the second floating diffusion node FD2, respectively. Thereafter, the pixel PIX may perform the first readout operation on the partial charges transferred to the first floating diffusion node FD1 in the HCG mode.

Next, the pixel PIX according to an embodiment of the disclosure enters the LCG mode, and the dual conversion gain transistor DCG may be turned on by the dual conversion signal VDC received from the row decoder 120. In this case, as described above, the first floating diffusion node FD1 and the second floating diffusion node FD2 may be electrically connected, to become the extended floating diffusion node. Accordingly, the partial charges accumulated in the first floating diffusion node FD1 and the remaining charges accumulated in the second floating diffusion node FD2 may be shared together to the extended floating diffusion node.

Finally, the pixel PIX according to an embodiment of the disclosure may perform the second readout operation on the charges shared to the extended floating diffusion node.

The reset transistor RG may be turned on by the reset signal VRST received from the row decoder 120, to provide a reset voltage (for example, the first power supply voltage VDD1) to the first floating diffusion node FD1 or the extended floating diffusion node. As a result, the charges accumulated in the first floating diffusion node FD1 or the extended floating diffusion node moves to the first power terminal, and the voltage of the first floating diffusion node FD1 or extended floating diffusion node may be reset.

The drive transistor DG may amplify a change of electrical potential of the first floating diffusion node FD1 or the extended floating diffusion node and may generate a voltage level (e.g., a pixel signal level) corresponding thereto. For example, the drive transistor DG may be driven as a source follower amplifier as the gate electrode is connected to the first floating diffusion node FD1 or the extended floating diffusion node and one terminal is connected to the second power terminal.

The selection transistor SEL may be driven by the selection signal VSEL received from the row decoder 120, to transfer the pixel signal generated by the drive transistor DG to the internal ADC.

The internal ADC may convert the pixel signal that is an analog signal into the digital signal based on the pixel signal received through the selection transistor SEL and the ramp signal RAMP received from the ramp generator 130.

The local memory may receive the digital signal corresponding to the pixel signal from the internal ADC, and store the digital signal. In an example case in which the pixel PIX performs the first readout operation or the second readout operation, the local memory may output the stored digital signal through the column line CL.

In FIG. 5, the pixel PIX is shown to be implemented based on a pixel-level ADC structure, such as a plurality of pixels included in the pixel array 110 of the image sensor 100 of FIG. 2B, but this is an example, and the scope of the disclosure is not limited thereto. For example, the pixel PIX may be implemented as a plurality of pixels included in the pixel array 110 of the image sensor 100 of FIG. 2A.

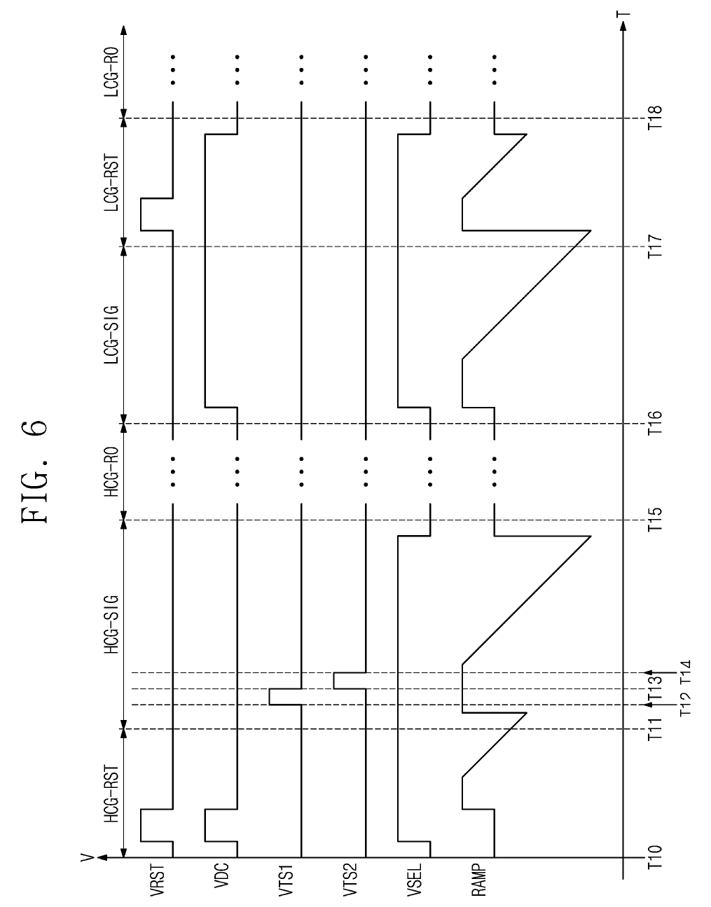

FIG. 6 is a timing diagram for describing an example of an operation of an image sensor, according to an embodiment of the disclosure. Referring to FIGS. 5 and 6, levels of the reset signal VRST, the dual conversion signal VDC, the first transfer signal VTS1, the second transfer signal VTS2, the selection signal VSEL, and the ramp signal RAMP according to time are exemplarily illustrated. In the timing diagram of FIG. 6, the horizontal axis represents time ‘T’, and the vertical axis represents voltage level ‘V’.

In a period between a tenth time point T10 and a sixteenth time point T16, the image sensor 100 may operate in the HCG mode, and in a period after the sixteenth times point T16, the image sensor 100 may operate in the LCG mode. The image sensor 100 may sample the HCG pixel signal in a period between the tenth time point T10 and a fifteenth time point T15, and the image sensor 100 may perform the first readout operation in a period between the fifteenth time points T15 and the sixteenth time points T16. In a period between the sixteenth time point T16 and a eighteenth time point T18, the image sensor 100 may sample the LCG pixel signal, and in a period after the eighteenth time point T18, the image sensor 100 may perform the second readout operation.

For example, in a period between the tenth time point T10 and an eleventh time point T11, the image sensor 100 may sample the HCG reset level for the HCG pixel signal, and in a period between an eleventh time point T11 and the fifteenth time point T15, the image sensor 100 may sample the HCG signal level. In addition, in a period between the sixteenth time point T16 and the seventeenth time point T17, the image sensor 100 may sample the HCG signal level for the LCG pixel signal, and in the period between the seventeenth time point T17 and the eighteenth time point T18, the image sensor 100 may sample the LCG reset level.

In the HCG-reset period HCG-RST (or the period between the tenth time point T10 and the eleventh time point T11), the voltages of the first floating diffusion node FD1 and the second floating diffusion node FD2 may be both reset. The HCG reset level may be converted into the digital signal by the internal ADC and stored in the local memory.

In the HCG-signal period HCG-SIG (or the period between the eleventh time point T11 and the fifteenth time point T15), charges transferred from the photodiode PD may be accumulated in the first floating diffusion node FD1 and the second floating diffusion node FD2, respectively.

In a period between a twelfth time point T12 and a thirteenth time point T13, the first transfer signal VTS1 may be a logical HIGH level. In the period between the twelfth time point T12 and the thirteenth time point T13, the first transfer transistor TG1 may be turned on, and the first transfer transistor TG1 may transfer the partial charges of the charges accumulated in the photodiode PD to the first floating diffusion node FD1.

In a period between the thirteenth time point T13 and the fourteenth time pointT14, the second transfer signal VTS2 may be a logical HIGH level, and both the first transfer signal VTS1 and the dual conversion signal VDC may be a logical LOW level. In the period between the thirteenth time T13 and the fourteenth time T14, the second transfer transistor TG2 may be turned on, and the second transfer transistor TG2 may transfer the remaining charges of the charges accumulated in the photodiode PD to the second floating diffusion node FD2.

In this case, the time period during which the image sensor 100 performs the first readout operation may not be included during the period between the twelfth time point T12 and the thirteenth time point T13, and the period between the thirteenth time point T13 and the fourteenth time point T14. That is, there may be no difference in the exposure integration time (EIT) between the period between the twelfth time point T12 and the thirteenth time point T13 and the period between the thirteenth time point T13 and the fourteenth time point T14.

According to an embodiment of the disclosure, before performing the first readout operation in the HCG mode, the image sensor 100 may perform both an operation of transferring the partial charges corresponding to the HCG pixel signal from the photodiode PD to the first floating diffusion node FD1 and an operation of transferring the remaining charges corresponding to the LCG pixel signal from the photodiode PD to the second floating diffusion node FD2.

In this case, the photodiode PD may not receive more light from the outside from after the image sensor 100 transfers the partial charges corresponding to the HCG pixel signal from the photodiode PD to the first floating diffusion node FD1 to before the image sensor 100 transfers the remaining charges corresponding to the LCG pixel signal from the photodiode PD to the second floating diffusion node FD2.

Therefore, according to an embodiment, the image sensor 100 illustrated in FIGS. 5 and 6 may improve the quality of the image by address the problem related to noise being generated in the image data as described above with reference to FIGS. 3 and 4. For example, the image sensor 100 illustrated in FIG. 5 has a configuration for removing the ghost image component from the image data.

In the HCG-signal period HCG-SIG (or the period between the eleventh time point T11 and the fifteenth time point T15), the HCG signal level may be converted into the digital signal by the internal ADC and stored in the local memory.

In the HCG-readout period HCG-RO (or the period between the fifteenth time point T15 and the sixteenth time point T16), the image sensor 100 may perform the first readout operation on the partial charges accumulated in the first floating diffusion node FD1. For example, the image sensor 100 may readout the digital signals respectively corresponding to the HCG reset level and the HCG signal level stored in the local memory through the column line CL.

In the LCG-signal period LCG-SIG (or the period between the sixteenth time point T16 and the seventeenth time point T17), the dual conversion gain transistor DCG may be turned on as the dual conversion signal VDC is changed into a logical HIGH level. As described above, the first floating diffusion node FD1 and the second floating diffusion node FD2 may be electrically connected, to become the extended floating diffusion node, and the partial charges accumulated in the first floating diffusion node FD1 and the remaining charges accumulated in the second floating diffusion node FD2 may be shared to the extended floating diffusion node. The LCG signal level may be converted into the digital signal by the ADC and stored in the local memory.

In the LCG-reset period LCG-RST (or the period between the seventeenth time point T17 and the eighteenth time point T18), the voltage of the extended floating diffusion node may be reset. The LCG reset level may be converted into the digital signal by the internal ADC and stored in the local memory.

In the LCG-readout period LCG-RO (or the period after the eighteenth time point T18), the image sensor 100 may perform the second readout operation on the charges shared to the extended floating diffusion node. For example, the image sensor 100 may readout the digital signals respectively corresponding to the LCG signal level and the LCG reset level stored in the local memory through the column line CL.

Similar to FIG. 4, in FIG. 6, the period during which the image sensor 100 samples the HCG pixel signal may include the HCG-reset period HCG-RST and the HCG signal period HCG-SIG. The period during which the image sensor 100 samples the LCG pixel signal may include the LCG-signal period LCG-SIG and the LCG-reset period LCG-RST. For example, the period during which the HCG pixel signal is sampled may be configured with the HCG-reset period HCG-RST and the HCG signal period HCG-SIG sequentially. For example, the period during which the LCG pixel signal is sampled may be configured with the LCG-signal period LCG-SIG and the LCG-reset period LCG-RST sequentially. That is, the image sensor 100 may perform RSSR (Reset-Sig-Sig-Reset) sampling.

However, the order of the HCG-reset period HCG-RST, the HCG signal period HCG-SIG, the LCG signal period LCG-SIG, and the LCG-reset period LCG-RST illustrated in FIG. 6 is an example, and the scope of the disclosure is not limited thereto. For example, the image sensor 100 may be configured to perform RSRS sampling, RRSS sampling, etc.

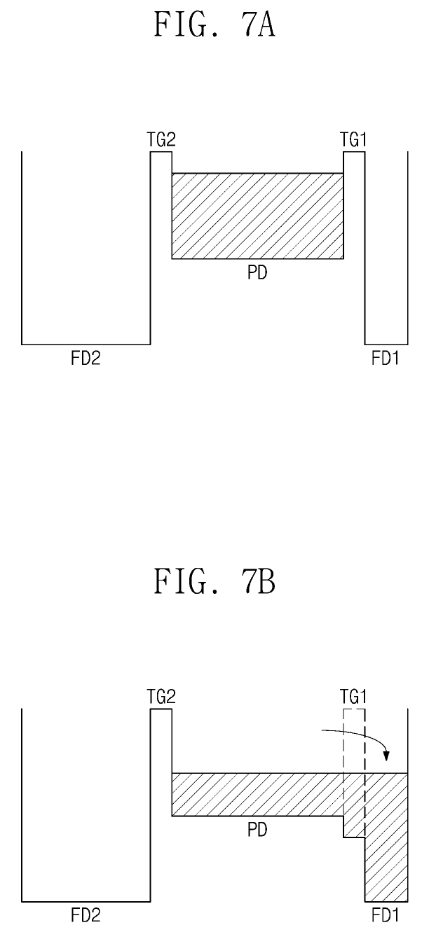

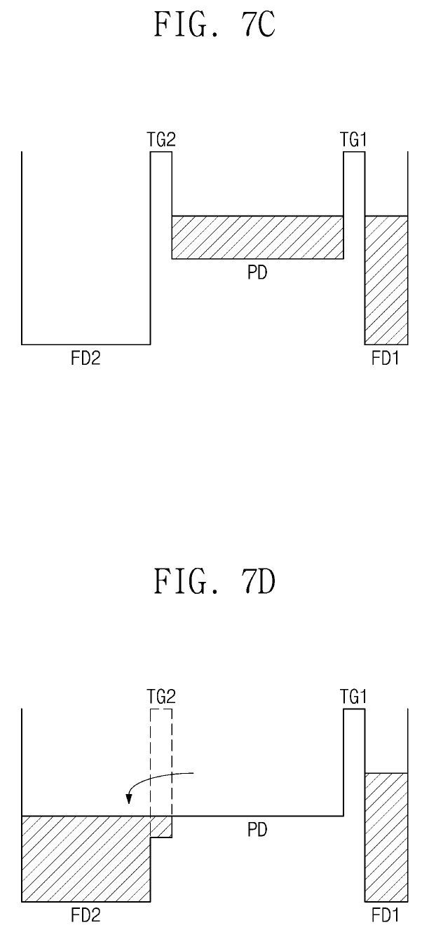

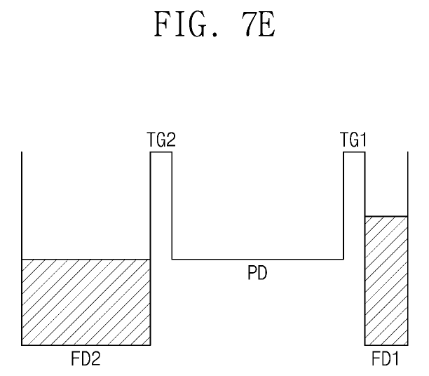

FIGS. 7A to 7E are diagrams conceptually describing an operation of a pixel, according to an embodiment of the disclosure. Referring to FIGS. 5, 6, and 7A to 7E, a flow (or a potential level) of the charges between the photodiode PD, the first floating diffusion node FD1, and the second floating diffusion node FD2 according to a flow of operation of the image sensor 100 is illustrated. Although not illustrated for simplicity of the drawings in FIGS. 7A to 7E, the dual conversion gain transistor DCG between the first floating diffusion node FD1 and the first floating diffusion node FD1 may be turned off.

FIG. 7A may correspond to a state in the HCG-reset period HCG-RST (or a period before the twelfth time point T12) of FIG. 6. For example, FIG. 7A may illustrate initial states of the charges of the photodiode PD, the first floating diffusion node FD1, and the second floating diffusion node FD2. Both the first transfer transistor TG1 and the second transfer transistor TG2 may be turned off. The charges generated by the photodiode PD based on the optical signal may be accumulated in the photodiode PD.

FIG. 7B may correspond to a state of the twelfth time point T12 of FIG. 6. The first transfer transistor TG1 may be turned on, and the second transfer transistor TG2 may be turned off. The partial charges of the charges accumulated in the photodiode PD may be accumulated in the first floating diffusion node FD1.

FIGS. 7C and 7D may correspond to a state of a thirteenth time point T13 of FIG. 6. After (or at the same time as) the first transfer transistor TG1 that has been turned on is turned off, the second transfer transistor TG2 may be turned on. Among the charges accumulated in the photodiode PD, the remaining charges except for the partial charges transferred to the first floating diffusion node FD1 may be accumulated in the second floating diffusion node FD2.

FIG. 7E may correspond to a state in the HCG-readout period HCG-RO (or a period between the fourteenth time point T14 and the sixteenth time point T16) of FIG. 6. Both the first transfer transistor TG1 and the second transfer transistor TG2 may be turned off. The partial charges and the remaining charges may be accumulated in the first floating diffusion node FD1 and the second floating diffusion node FD2, respectively. The image sensor 100 may perform the first readout operation on the partial charges accumulated in the first floating diffusion node FD1.

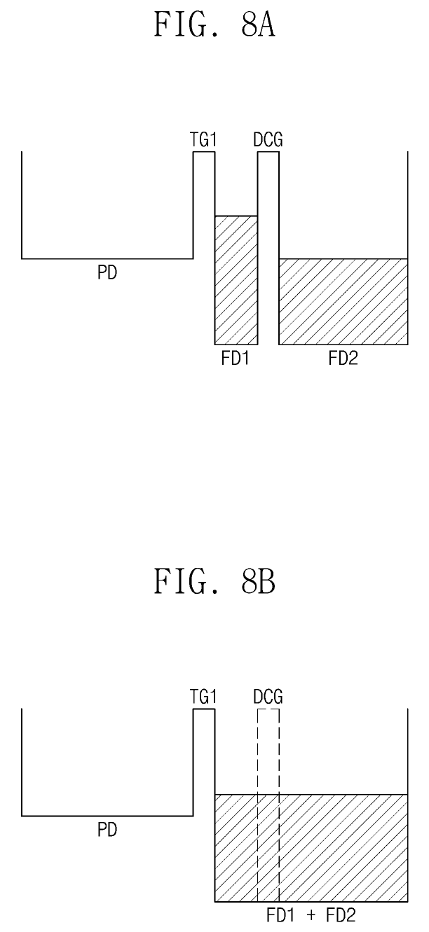

FIGS. 8A and 8B are diagrams conceptually describing an operation of a pixel according to an embodiment of the disclosure. Referring to FIGS. 5, 6, 7A to 7E, and 8A and FIG. 8B, a flow (or a potential level) of the charges between the photodiode PD, the first floating diffusion node FD1, and the second floating diffusion node FD2 according to a flow of operation of the image sensor 100 is illustrated. Although not illustrated for simplicity of the drawings in FIGS. 8A and 8B, the second transfer transistor TG2 between the second floating diffusion node FD2 and the photodiode PD may be turned off.

The state of FIG. 8A may correspond to the state of FIG. 7E. Both the first transfer transistor TG1 and the dual conversion gain transistor DCG may be turned off.

FIG. 8B may correspond to a state in the LCG-signal period LCG-SIG (or the period between the sixteenth time point T16 and the seventeenth time point T17) of FIG. 6. The first transfer transistor TG1 may be turned off, and the dual conversion gain transistor DCG may be turned on. The capacitance of the extended floating diffusion node may be extended to the sum of the capacitances of the first floating diffusion node FD1 and the second floating diffusion node FD2. Both the partial charges and the remaining charges may be shared to the extended floating diffusion node.

On the other hand, as described above, the capacitance of the extended floating diffusion node in the disclosure has been described assuming that it is sufficient to accommodate all the charges accumulated in the photodiode PD, but the scope of the disclosure is not limited thereto. For example, the capacitance of the extended floating diffusion node may not be sufficient to accommodate all the charges accumulated in the photodiode PD. In this case, a part (or at least a part) of the remaining charges except for the partial charges corresponding to the capacitance of the first floating diffusion node FD1 of the charges accumulated in the photodiode PD may be accumulated in the second floating diffusion node FD2.

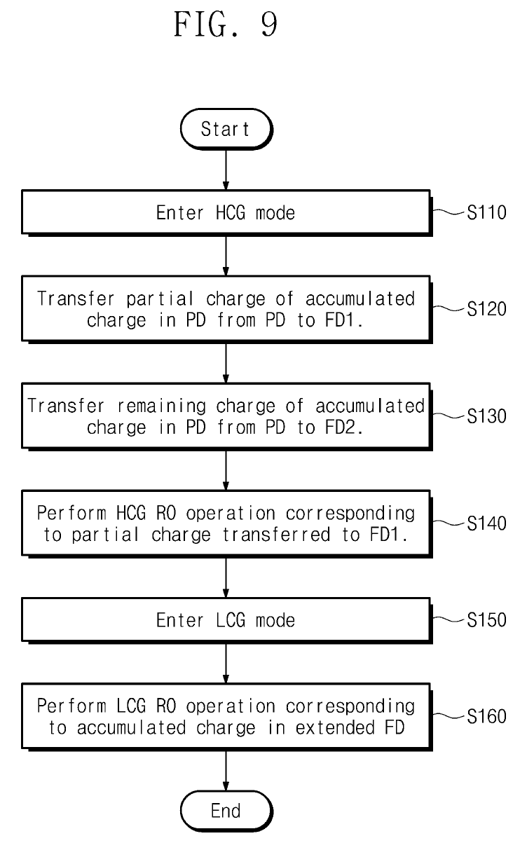

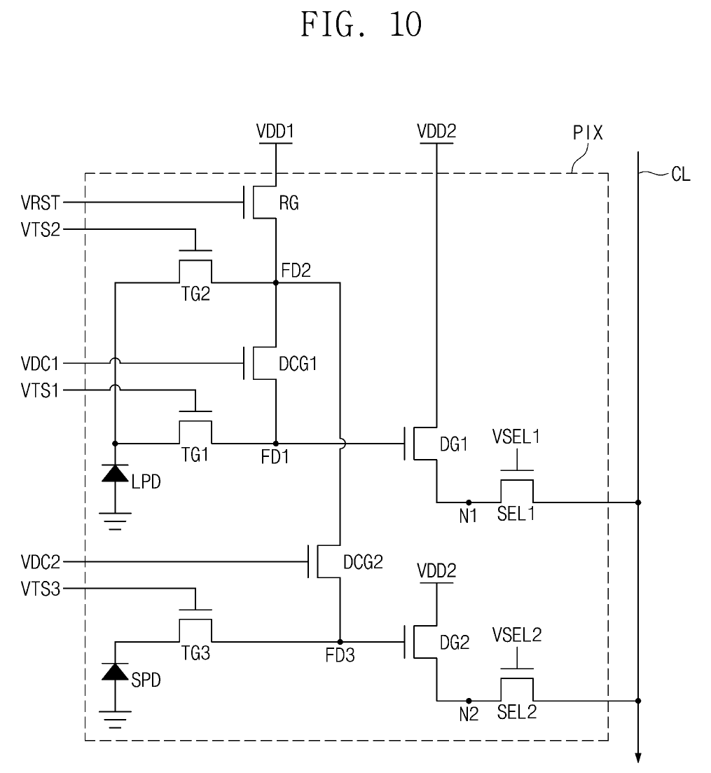

FIG. 9 is a flowchart illustrating an example of an operation of an image sensor, according to an embodiment of the disclosure. Referring to FIGS. 2A, 2B, 5, 6, 7A to 7E, 8A, 8B, and 9, in operation S110, the image sensor 100 may enter the HCG mode. For example, each of the plurality of pixels included in the image sensor 100 may enter the HCG mode. For example, the dual conversion gain transistor DCG of the pixel PIX may be turned off.

In operation S120, the image sensor 100 may transfer the partial charges of the charges accumulated in the photodiode PD from the photodiode PD to the first floating diffusion node FD1. For example, the first transfer transistor TG1 of each of the plurality of pixels included in the image sensor 100 may transfer the partial charges of the charges accumulated in the photodiode PD from the photodiode PD to the first floating diffusion node FD1 based on the first transfer signal VTS1.

In operation S130, the image sensor 100 may transfer the remaining charges from the photodiode PD to the second floating diffusion node FD2. For example, based on the second transfer signal VTS2, the second transfer transistor TG2 of each of the plurality of pixels included in the image sensor 100 may transfer the remaining charges except for a part of the charges transferred to the first floating diffusion node FD1 of the charges accumulated in the photodiode PD from the photodiode PD to the second floating diffusion node FD2.

In operation S140, the image sensor 100 may perform the HCG readout operation corresponding to the partial charges transferred to the first floating diffusion node FD1. For example, each of the plurality of pixels included in the image sensor 100 may perform the first readout operation for the HCG pixel signal.

In operation S150, the image sensor 100 may enter the LCG mode. For example, each of the plurality of pixels included in the image sensor 100 may enter the LCG mode. For example, the dual conversion gain transistor DCG of the pixel PIX may be turned on.

In operation S160, the image sensor 100 may perform the LCG readout operation corresponding to the charges shared to the extended floating diffusion node. For example, each of the plurality of pixels included in the image sensor 100 may perform the second readout operation for the LCG pixel signal.

FIG. 10 is a circuit diagram illustrating a pixel, according to an embodiment of the disclosure. Referring to FIGS. 2A, 2B, 5, and 10, the pixel PIX may include a large photodiode LPD, a first transfer transistor TG1, a second transfer transistor TG2, a first dual conversion gain transistor DCG1, a reset transistor RG, a first drive transistor DG1, a first selection transistor SEL1, a small photodiode SPD, a third transfer transistor TG3, a second dual conversion gain transistor DCG2, a second drive transistor DG2, and a second selection transistor SEL2. The pixel PIX of FIG. 10 may further include the small photodiode SPD, the third transfer transistor TG3, the second dual conversion gain transistor DCG2, the second drive transistor DG2, and the second selection transistor SEL2 compared to the pixel PIX of FIG. 5. The photodiode PD, the dual conversion gain transistor DCG, the drive transistor DG, and the selection transistor SEL of the pixel PIX of FIG. 5 may correspond to the large photodiode LPD, the first dual conversion gain transistor DCG1, the first drive transistor DG1, and the first selection transistor SEL1 of the pixel PIX of FIG. 10, respectively.

The third transfer transistor TG3 may be connected between the small photodiode SPD and a third floating diffusion node FD3, and may include a gate electrode that receives a third transfer signal VTS3.

The second dual conversion gain transistor DCG2 may be connected between the second floating diffusion node FD2 and the third floating diffusion node FD3 and may include a gate electrode that receives a second dual conversion signal VDC2. In an example case in which the second dual conversion signal VDC2 is a logical HIGH level, the second dual conversion gain transistor DCG2 may be turned on, and the second floating diffusion node FD2 and the third floating diffusion node FD3 may be electrically connected.

The second drive transistor DG2 may be connected between a third power terminal and a second node N2 and may include a gate electrode connected to the third floating diffusion node FD3. Here, the third power terminal may receive the second power voltage VDD2.

The second selection transistor SEL2 may be connected between the second node N2 and the column line CL, and may include a gate electrode that receives a second selection signal VSEL2.

Similar to the large photodiode LPD, the small photodiode SPD may accumulate charges based on the optical signal incident from the outside. For example, the small photodiode SPD may generate the charges corresponding to the intensity of light incident from the outside and accumulate the generated charges.

The third transfer transistor TG3 may operate based on the third transfer signal VTS3, the second dual conversion gain transistor DCG2 may operate based on the second dual conversion signal VDC2, the second drive transistor DG2 may operate in response the voltage of the third floating diffusion node FD3, and the second selection transistor SEL2 may operate based on the second selection signal VSEL2. The first transfer transistor TG1, the second transfer transistor TG2, the first dual conversion gain transistor DCG1, the reset transistor RG, the first drive transistor DG1, and the first selection transistor SEL1 are configured to be the same as described above with reference to FIGS. 3 and 5, and thus redundant descriptions thereof are omitted.

According to an embodiment, the pixel PIX of FIG. 10 may be a pixel PIX having a split photodiode (Split PD) structure including a plurality of photodiodes LPD and SPD. For example, the pixel PIX may include the large photodiode LPD having a large light receiving area and the small photodiode SPD having a small light receiving area.

For example, the large photodiode LPD may be responsible for the pixel signal for light having low illuminance, and the small photodiode SPD may be responsible for the pixel signal for light having high illuminance. For example, the pixel PIX may convert a low-illuminance optical signal with a relatively high conversion gain based on the large photodiode LPD, and may convert a high-illuminant optical signal with a relative low conversion gain based on the small photodiode SPD.

According to an embodiment, the pixel PIX having the split photodiode structure, such as the pixel PIX shown in FIG. 10, may also perform the same as the function and the operation of the pixel PIX described above with reference to FIGS. 5 to 9. For example, the large photodiode LPD, the first transfer transistor TG1, the second transfer transistor TG2, the first dual conversion gain transistor DCG1, the reset transistor RG, the first drive transistor DG1, and the first selection transistor SEL1 of the pixel PIX may operate the same as the photodiode PD, the first transfer transistor TG1, the second transfer transistor TG2, the dual conversion gain transistor DCG, the reset transistor RG, the drive transistor DG, and the selection transistor SEL of the pixel PIX according to an embodiment of the disclosure, respectively. Therefore, redundant descriptions of the operation of the pixel PIX illustrated in FIG. 10 are omitted.

In FIG. 10, the pixel PIX is illustrated to be implemented as a plurality of pixels included in the pixel array 110 of the image sensor 100 of FIG. 2A, but this is an example, and the scope of the disclosure is not limited thereto. For example, the pixel PIX may be implemented based on a pixel-level ADC structure, such as a plurality of pixels included in the pixel array 110 of the image sensor 100 of FIG. 2B.

According to an embodiment of the disclosure, there is provided a method of operating an image sensor. The method includes accumulating, by a photodiode of the image sensor, charges based on an optical signal, entering a high conversion gain mode, transferring partial charges of the accumulated charges to a first floating diffusion node, transferring at least a part of remaining charges of the accumulated charges to a second floating diffusion node, performing a first readout operation corresponding to the partial charges transferred to the first floating diffusion node, and entering a low conversion gain mode.

For example, while the pixel is operation in the high conversion gain mode, the method includes transferring partial charges of the accumulated charges to a first floating diffusion node, transferring at least a part of remaining charges of the accumulated charges to a second floating diffusion node, and performing a first readout operation corresponding to the partial charges transferred to the first floating diffusion node, and entering a low conversion gain mode.

The image sensor may include a pixel including the photodiode, a first transfer transistor, a second transfer transistor, a dual conversion transistor, a reset transistor, a drive transistor, and a select transistor. The first transfer transistor may be connected between the photodiode and the first floating diffusion node, the first transfer transistor configured to operate based on a first transfer signal. The second transfer transistor may be connected between the photodiode and the second floating diffusion node, the second transfer transistor configured to operate based on a second transfer signal. The dual conversion transistor may be connected between the first floating diffusion node and the second floating diffusion node, the dual conversion transistor configured to operate based on a dual conversion signal. The reset transistor may be connected between a first power terminal and the second floating diffusion node, the reset transistor configured to operate based on a reset signal. The drive transistor may be connected between a second power terminal and a first node, the drive transistor configured to operate based on a voltage of the first floating diffusion node. The select transistor may be connected between the first node and a column line, the select transistor configured to operate based on a selection signal.

The entering the high conversion gain mode may include turning off the dual conversion transistor.

The transferring the partial charges may include turning on the first transfer transistor, and turning off the first transfer transistor after the partial charges is transferred to the first floating diffusion node.

The transferring at least a part of the remaining charges may include turning on the second transfer transistor, and turning off the second transfer transistor after at least a part of the remaining charges are transferred to the second floating diffusion node.

The entering the low conversion gain mode may include turning on the dual conversion transistor.

The method may further include electrically connecting the first floating diffusion node and the second floating diffusion node to generate an extended floating diffusion node.

The method may further include sharing the partial charges transferred to the first floating diffusion node and at least a part of the remaining charges transferred to the second floating diffusion node to the extended floating diffusion node.

The method may further include performing a second readout operation corresponding to the charges shared to the extended floating diffusion node.

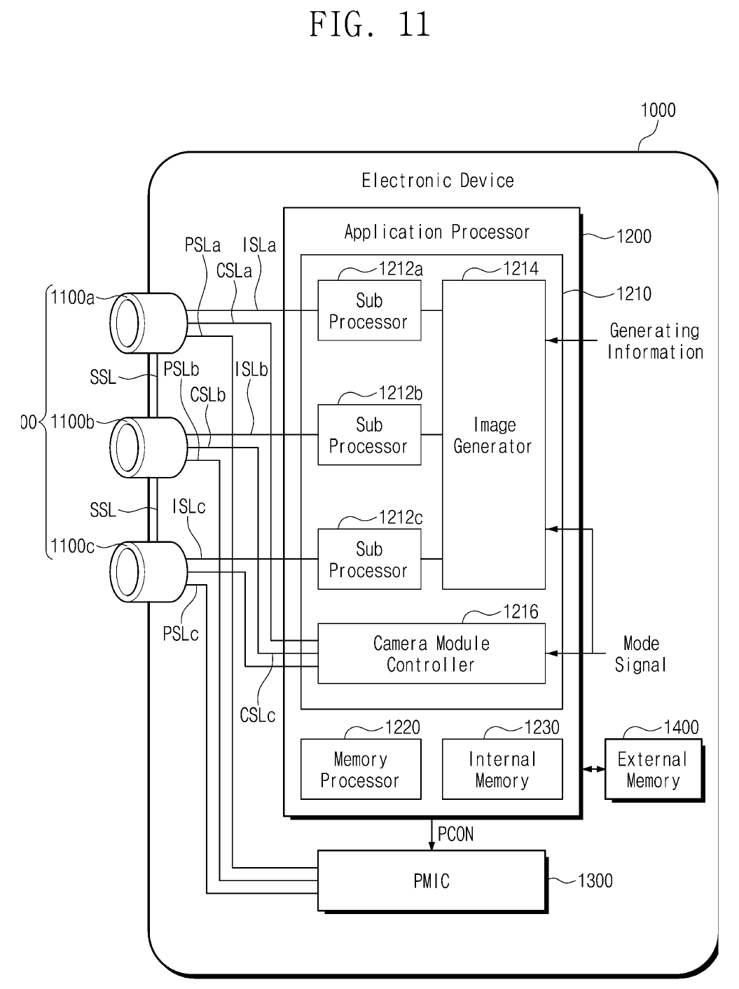

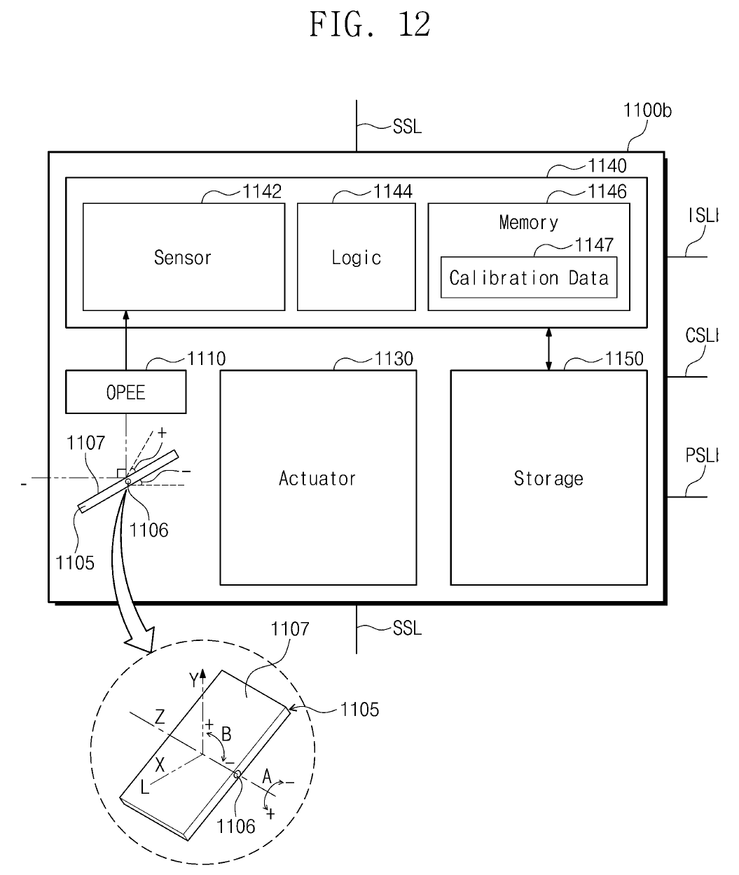

FIG. 11 is a block diagram of an electronic device including a multi-camera module. FIG. 12 is a block diagram illustrating a camera module of FIG. 11 in detail.

Referring to FIG. 11, an electronic device 1000 may include a camera module group 1100, an application processor 1200, a PMIC 1300, and an external memory 1400.

The camera module group 1100 may include a plurality of camera modules 1100a, 1100b, and 1100c. An electronic device including three camera modules 1100a, 1100b, and 1100c is illustrated in FIG. 11, but the disclosure is not limited thereto. In some embodiments, the camera module group 1100 may be modified to include only two camera modules. Also, in some embodiments, the camera module group 1100 may be modified to include “n” camera modules (n being a natural number of 4 or more).

In one embodiment, the image sensor 100 of FIG. 2A or FIG. 2B may be included in the camera module group 1100. However, the disclosure is not limited thereto

Below, a detailed configuration of the camera module 1100b will be more fully described with reference to FIG. 12, but the following description may be equally applied to the remaining camera modules 1100a and 1100c.

Referring to FIG. 12, the camera module 1100b may include a prism 1105, an optical path folding element (OPFE) 1110, an actuator 1130, an image sensing device 1140, and storage 1150.

The prism 1105 may include a reflecting plane 1107 of a light reflecting material and may change a path of a light “L” incident from the outside.

In some embodiments, the prism 1105 may change a path of the light “L” incident in a first direction (X) to a second direction (Y) perpendicular to the first direction (X), Also, the prism 1105 may change the path of the light “L” incident in the first direction (X) to the second direction (Y) perpendicular to the first (X-axis) direction by rotating the reflecting plane 1107 of the light reflecting material in direction “A” about a central axis 1106 or rotating the central axis 1106 in direction “B”. In this case, the OPFE 1110 may move in a third direction (Z) perpendicular to the first direction (X) and the second direction (Y).

In some embodiments, as illustrated in FIG. 12, a maximum rotation angle of the prism 1105 in direction “A” may be equal to or smaller than 15 degrees in a positive A direction and may be greater than 15 degrees in a negative A direction, but the disclosure is not limited thereto.

In some embodiments, the prism 1105 may move within approximately 20 degrees in a positive or negative B direction, between 10 degrees and 20 degrees, or between 15 degrees and 20 degrees; here, the prism 1105 may move at the same angle in the positive or negative B direction or may move at a similar angle within approximately 1 degree.

In some embodiments, the prism 1105 may move the reflecting plane 1107 of the light reflecting material in the third direction (e.g., Z direction) parallel to a direction in which the central axis 1106 extends.

The OPFE 1110 may include optical lenses composed of “m” groups (m being a natural number), for example. Here, “m” lens may move in the second direction (Y) to change an optical zoom ratio of the camera module 1100b. In an example case in which a default optical zoom ratio of the camera module 1100b is “Z”, the optical zoom ratio of the camera module 1100b may be changed to an optical zoom ratio of 3Z, 5Z, or 5Z or more by moving “m” optical lens included in the OPFE 1110.

The actuator 1130 may move the OPFE 1110 or an optical lens (hereinafter referred to as an “optical lens”) to a specific location. For example, the actuator 1130 may adjust a location of an optical lens such that an image sensor 1142 is placed at a focal length of the optical lens for accurate sensing.

The image sensing device 1140 may include the image sensor 1142, control logic 1144, and a memory 1146. The image sensor 1142 may sense an image of a sensing target by using the light “L” provided through an optical lens. The control logic 1144 may control overall operations of the camera module 1100b. For example, the control logic 1144 may control an operation of the camera module 1100b based on a control signal provided through a control signal line CSLb.

The memory 1146 may store information, which is necessary for an operation of the camera module 1100b, such as calibration data 1147. The calibration data 1147 may include information necessary for the camera module 1100b to generate image data by using the light “L” provided from the outside. The calibration data 1147 may include, for example, information about the degree of rotation described above, information about a focal length, information about an optical axis, etc. In the case where the camera module 1100b is implemented in the form of a multi-state camera in which a focal length varies depending on a location of an optical lens, the calibration data 1147 may include a focal length value for each location (or state) of the optical lens and information about auto focusing.

The storage 1150 may store image data sensed through the image sensor 1142. The storage 1150 may be provided outside the image sensing device 1140 and may be implemented in a shape where the storage 1150 and a sensor chip constituting the image sensing device 1140 are stacked. In some embodiments, the storage 1150 may be implemented with an electrically erasable programmable read only memory (EEPROM), but the disclosure is not limited thereto.

Referring together to FIGS. 14 and 15, in some embodiments, each of the plurality of camera modules 1100a, 1100b, and 1100c may include the actuator 1130. As such, the same calibration data 1147 or different calibration data 1147 may be included in the plurality of camera modules 1100a, 1100b, and 1100c depending on operations of the actuators 1130 therein.

In some embodiments, one camera module (e.g., 1100b) among the plurality of camera modules 1100a, 1100b, and 1100c may be a folded lens shape of camera module in which the prism 1105 and the OPFE 1110 described above are included, and the remaining camera modules (e.g., 1100a and 1100c) may be a vertical shape of camera module in which the prism 1105 and the OPFE 1110 described above are not included; however, the disclosure is not limited thereto.

In some embodiments, one camera module (e.g., 1100c) among the plurality of camera modules 1100a, 1100b, and 1100c may be, for example, a vertical shape of depth camera extracting depth information by using an infrared ray (IR). In this case, the application processor 1200 may merge image data provided from the depth camera and image data provided from any other camera module (e.g., 1100a or 1100b) and may generate a three-dimensional (3D) depth image.

In some embodiments, at least two camera modules (e.g., 1100a and 1100b) among the plurality of camera modules 1100a, 1100b, and 1100c may have different fields of view. In this case, the at least two camera modules (e.g., 1100a and 1100b) among the plurality of camera modules 1100a, 1100b, and 1100c may include different optical lens, but the disclosure is not limited thereto.

Also, in some embodiments, fields of view of the plurality of camera modules 1100a, 1100b, and 1100c may be different. In this case, the plurality of camera modules 1100a, 1100b, and 1100c may include different optical lens, not limited thereto.

In some embodiments, the plurality of camera modules 1100a, 1100b, and 1100c may be provided to be physically separated from each other. That is, the plurality of camera modules 1100a, 1100b, and 1100c may not use a sensing area of one image sensor 1142, but the plurality of camera modules 1100a, 1100b, and 1100c may include independent image sensors 1142 therein, respectively.

Returning to FIG. 11, the application processor 1200 may include an image processing device 1210, a memory controller 1220, and an internal memory 1230. The application processor 1200 may be implemented to be separated from the plurality of camera modules 1100a, 1100b, and 1100c. For example, the application processor 1200 and the plurality of camera modules 1100a, 1100b, and 1100c may be implemented with separate semiconductor chips.

The image processing device 1210 may include a plurality of sub image processors 1212a, 1212b, and 1212c, an image generator 1214, and a camera module controller 1216.

The image processing device 1210 may include the plurality of sub image processors 1212a, 1212b, and 1212c, the number of which corresponds to the number of the plurality of camera modules 1100a, 1100b, and 1100c.

Image data respectively generated from the camera modules 1100a, 1100b, and 1100c may be respectively provided to the corresponding sub image processors 1212a, 1212b, and 1212c through separated image signal lines ISLa, ISLb, and ISLc. For example, the image data generated from the camera module 1100a may be provided to the sub image processor 1212a through the image signal line ISLa, the image data generated from the camera module 1100b may be provided to the sub image processor 1212b through the image signal line ISLb, and the image data generated from the camera module 1100c may be provided to the sub image processor 1212c through the image signal line ISLc. This image data transmission may be performed, for example, by using a camera serial interface (CSI) based on the MIPI (Mobile Industry Processor Interface), but the disclosure is not limited thereto.

Meanwhile, in some embodiments, one sub image processor may be provided to correspond to a plurality of camera modules. For example, the sub image processor 1212a and the sub image processor 1212c may be integrally implemented, not separated from each other as illustrated in FIG. 16; in this case, one of the pieces of image data respectively provided from the camera module 1100a and the camera module 1100c may be selected through a selection element (e.g., a multiplexer), and the selected image data may be provided to the integrated sub image processor.

The image data respectively provided to the sub image processors 1212a, 1212b, and 1212c may be provided to the image generator 1214. The image generator 1214 may generate an output image by using the image data respectively provided from the sub image processors 1212a, 1212b, and 1212c, depending on image generating information (Generating Information) or a mode signal.

In detail, the image generator 1214 may generate the output image by merging at least a portion of the image data respectively generated from the camera modules 1100a, 1100b, and 1100c having different fields of view, depending on the image generating information Generating Information or the mode signal. Also, the image generator 1214 may generate the output image by selecting one of the image data respectively generated from the camera modules 1100a, 1100b, and 1100c having different fields of view, depending on the image generating information Generating Information or the mode signal.

In some embodiments, the image generating information Generating Information may include a zoom signal or a zoom factor. Also, in some embodiments, the mode signal may be, for example, a signal based on a mode selected from a user.

In the case where the image generating information Generating Information is the zoom signal (or zoom factor) and the camera modules 1100a, 1100b, and 1100c have different visual fields of view, the image generator 1214 may perform different operations depending on a kind of the zoom signal. For example, in the case where the zoom signal is a first signal, the image generator 1214 may merge the image data output from the camera module 1100a and the image data output from the camera module 1100c and may generate the output image by using the merged image signal and the image data output from the camera module 1100b that is not used in the merging operation. In the case where the zoom signal is a second signal different from the first signal, without the image data merging operation, the image generator 1214 may select one of the image data respectively output from the camera modules 1100a, 1100b, and 1100c and may output the selected image data as the output image. However, the disclosure is not limited thereto, and a way to process image data may be modified without limitation if necessary.

In some embodiments, the image generator 1214 may generate merged image data having an increased dynamic range by receiving a plurality of image data of different exposure times from at least one of the plurality of sub image processors 1212a, 1212b, and 1212c and performing high dynamic range (HDR) processing on the plurality of image data.

The camera module controller 1216 may provide control signals to the camera modules 1100a, 1100b, and 1100c, respectively. The control signals generated from the camera module controller 1216 may be respectively provided to the corresponding camera modules 1100a, 1100b, and 1100c through control signal lines CSLa, CSLb, and CSLc separated from each other.

One of the plurality of camera modules 1100a, 1100b, and 1100c may be designated as a master camera (e.g., 1100b) depending on the image generating information Generating Information including a zoom signal or the mode signal, and the remaining camera modules (e.g., 1100a and 1100c) may be designated as a slave camera. The above designation information may be included in the control signals, and the control signals including the designation information may be respectively provided to the corresponding camera modules 1100a, 1100b, and 1100c through the control signal lines CSLa, CSLb, and CSLc separated from each other.

Camera modules operating as a master and a slave may be changed depending on the zoom factor or an operating mode signal. For example, in the case where the field of view of the camera module 1100a is wider than the field of view of the camera module 1100b and the zoom factor indicates a low zoom ratio, the camera module 1100b may operate as a master, and the camera module 1100a may operate as a slave. In contrast, in the case where the zoom factor indicates a high zoom ratio, the camera module 1100a may operate as a master, and the camera module 1100b may operate as a slave.

In some embodiments, the control signal provided from the camera module controller 1216 to each of the camera modules 1100a, 1100b, and 1100c may include a sync enable signal. For example, in the case where the camera module 1100b is used as a master camera and the camera modules 1100a and 1100c are used as a slave camera, the camera module controller 1216 may transmit the sync enable signal to the camera module 1100b. The camera module 1100b that is provided with sync enable signal may generate a sync signal based on the provided sync enable signal and may provide the generated sync signal to the camera modules 1100a and 1100c through a sync signal line SSL. The camera module 1100b and the camera modules 1100a and 1100c may be synchronized with the sync signal to transmit image data to the application processor 1200.

In some embodiments, the control signal provided from the camera module controller 1216 to each of the camera modules 1100a, 1100b, and 1100c may include mode information according to the mode signal. Based on the mode information, the plurality of camera modules 1100a, 1100b, and 1100c may operate in a first operating mode and a second operating mode with regard to a sensing speed.

In the first operating mode, the plurality of camera modules 1100a, 1100b, and 1100c may generate image signals at a first speed (e.g., may generate image signals of a first frame rate), may encode the image signals at a second speed (e.g., may encode the image signal of a second frame rate higher than the first frame rate), and transmit the encoded image signals to the application processor 1200. In this case, the second speed may be 30 times or less the first speed.

The application processor 1200 may store the received image signals, that is, the encoded image signals in the memory 1230 provided therein or the external memory 1400 placed outside the application processor 1200. Afterwards, the application processor 1200 may read and decode the encoded image signals from the memory 1230 or the external memory 1400 and may display image data generated based on the decoded image signals. For example, the corresponding one among sub image processors 1212a, 1212b, and 1212c of the image processing device 1210 may perform decoding and may also perform image processing on the decoded image signal.

In the second operating mode, the plurality of camera modules 1100a, 1100b, and 1100c may generate image signals at a third speed (e.g., may generate image signals of a third frame rate lower than the first frame rate) and transmit the image signals to the application processor 1200. The image signals provided to the application processor 1200 may be signals that are not encoded. The application processor 1200 may perform image processing on the received image signals or may store the image signals in the memory 1230 or the external memory 1400.

The PMIC 1300 may supply powers, for example, power supply voltages to the plurality of camera modules 1100a, 1100b, and 1100c, respectively. For example, under control of the application processor 1200, the PMIC 1300 may supply a first power to the camera module 1100a through a power signal line PSLa, may supply a second power to the camera module 1100b through a power signal line PSLb, and may supply a third power to the camera module 1100c through a power signal line PSLc.

According to an embodiment, based on a power control signal PCON from the application processor 1200, the PMIC 1300 may generate a power corresponding to each of the plurality of camera modules 1100a, 1100b, and 1100c and may adjust a level of the power. The power control signal PCON may include a power adjustment signal for each operating mode of the plurality of camera modules 1100a, 1100b, and 1100c. For example, the operating mode may include a low-power mode. In this case, the power control signal PCON may include information about a camera module operating in the low-power mode and a set power level. Levels of the powers respectively provided to the plurality of camera modules 1100a, 1100b, and 1100c may be identical to each other or may be different from each other. Also, a level of a power may be dynamically changed.

The above descriptions are detail embodiments for carrying out the disclosure. Embodiments in which a design is simply changed or which are easily changed may be included in the disclosure as well as an embodiment described above. In addition, technologies that are easily changed and implemented by using the above embodiments may be included in the disclosure. Therefore, the scope of the disclosure should not be limited to the above-described embodiments and should be defined by not only the claims to be described later, but also those equivalent to the claims of the disclosure.

What is claimed is:

1. An image sensor comprising:
a pixel, wherein the pixel comprises:
a photodiode configured to accumulate charges based on an optical signal;
a first transfer transistor connected between the photodiode and a first floating diffusion node, the first transfer transistor configured to operate based on a first transfer signal;
a second transfer transistor connected between the photodiode and a second floating diffusion node, the second transfer transistor configured to operate based on a second transfer signal;
a dual conversion transistor connected between the first floating diffusion node and the second floating diffusion node, the dual conversion transistor configured to operate based on a dual conversion signal;
a reset transistor connected between a first power terminal and the second floating diffusion node, the reset transistor configured to operate based on a reset signal;
a drive transistor connected between a second power terminal and a first node, the drive transistor configured to operate based on a voltage of the first floating diffusion node; and
a select transistor connected between the first node and a column line, the select transistor configured to operate based on a selection signal.

2. The image sensor of claim 1, wherein, based on the dual conversion transistor being turned off, the pixel is configured to operate in a high conversion gain mode,
wherein, based on the dual conversion transistor being turned on, the pixel is configured to operate in a low conversion gain mode, and
wherein, the pixel is configured to operate in the low conversion gain mode after operating in the high conversion gain mode.

3. The image sensor of claim 2, wherein, in a period during which the pixel operates in the high conversion gain mode:
the first transfer transistor is turned on from a turned off state, and then turned off again; and
after the first transfer transistor is turned off again, the second transfer transistor is turned on from a turned off state, and then turned off again.

4. The image sensor of claim 3, wherein, in a period during which the first transfer transistor is turned on, the first transfer transistor is configured to transfer partial charges of the charges accumulated in the photodiode to the first floating diffusion node, and
wherein, after the first transfer transistor is turned off again, in a period during which the second transfer transistor is turned on, the second transfer transistor is configured to at least a part of remaining charges of the charges accumulated in the photodiode to the second floating diffusion node.

5. The image sensor of claim 4, wherein, after the second transfer transistor is turned off again, the image sensor is configured to perform a first readout operation corresponding to the partial charges transferred to the first floating diffusion node.

6. The image sensor of claim 5, wherein, after performing the first readout operation, the pixel is configured to operate in the low conversion gain mode, and the dual conversion transistor is configured to be turned on from a turned off state.

7. The image sensor of claim 6, wherein, in a period during which the dual conversion transistor is turned on, the dual conversion transistor is configured to electrically connect the first floating diffusion node and the second floating diffusion node, to generate an extended floating diffusion node.

8. The image sensor of claim 7, wherein, the dual conversion transistor is configured to share the partial charges transferred to the first floating diffusion node and at least a part of the remaining charges transferred to the second floating diffusion node to the extended floating diffusion node.

9. The image sensor of claim 8, wherein, the image sensor is configured to perform a second readout operation corresponding to the charges shared to the extended floating diffusion node.

10. An image sensor comprising:
a pixel comprising:
a first transfer transistor,
a second transfer transistor, and
a photodiode configured to accumulate charges based on an optical signal,
wherein, based on the pixel operating in a high conversion gain mode:
the first transfer transistor is configured to transfer partial charges of the charges accumulated in the photodiode to a first floating diffusion node, and
the second transfer transistor is configured to transfer at least a part of remaining charges of the charges accumulated in the photodiode to a second floating diffusion node, and
wherein a first readout operation is performed corresponding to the partial charges transferred to the first floating diffusion node; and
wherein the pixel is configured to enter a low conversion gain mode after the first readout operation.

11. The image sensor of claim 10, wherein, the pixel further comprises a dual conversion transistor, a reset transistor, a drive transistor, and a select transistor;
wherein the first transfer transistor is connected between the photodiode and the first floating diffusion node, the first transfer transistor configured to operate based on a first transfer signal;
wherein the second transfer transistor is connected between the photodiode and the second floating diffusion node, the second transfer transistor configured to operate based on a second transfer signal;
wherein the dual conversion transistor is connected between the first floating diffusion node and the second floating diffusion node, the dual conversion transistor configured to operate based on a dual conversion signal;
wherein the reset transistor is connected between a first power terminal and the second floating diffusion node, the reset transistor configured to operate based on a reset signal;
wherein the drive transistor is connected between a second power terminal and a first node, the drive transistor configured to operate based on a voltage of the first floating diffusion node; and
wherein the select transistor is connected between the first node and a column line, the select transistor configured to operate based on a selection signal.

12. The image sensor of claim 11, wherein the entering the high conversion gain mode comprises turning off the dual conversion transistor.

13. The image sensor of claim 11, wherein the transferring the partial charges comprises:
turning on the first transfer transistor; and
turning off the first transfer transistor after the partial charges is transferred to the first floating diffusion node.

14. The image sensor of claim 11, wherein the transferring at least a part of the remaining charges comprises:
turning on the second transfer transistor; and
turning off the second transfer transistor after at least a part of the remaining charges are transferred to the second floating diffusion node.

15. The image sensor of claim 11, wherein the entering the low conversion gain mode comprises turning on the dual conversion transistor.

16. The image sensor of claim 15, wherein the first floating diffusion node and the second floating diffusion node are electrically connected to generate an extended floating diffusion node.

17. The image sensor of claim 16, wherein
the pixel is further configured to share the partial charges transferred to the first floating diffusion node and at least a part of the remaining charges transferred to the second floating diffusion node to the extended floating diffusion node.

18. The image sensor of claim 17, wherein the pixel is further configured to perform a second readout operation corresponding to the charges shared to the extended floating diffusion node.

19. An image sensor comprising:
a pixel array comprising a plurality of pixels;
a timing controller configured to generate control signal; and
a row decoder configured to generate, based on the control signal, at least one of a first transfer signal, a second transfer signal, a dual conversion signal, a reset signal, and a selection signal to drive the pixel array,
wherein, each of the plurality of pixels comprises:
a photodiode configured to accumulate charges based on an optical signal;
a first transfer transistor connected between the photodiode and a first floating diffusion node, the first transfer transistor configured to operate based on a first transfer signal;
a second transfer transistor connected between the photodiode and a second floating diffusion node, the second transfer transistor configured to operate based on a second transfer signal;
a dual conversion transistor connected between the first floating diffusion node and the second floating diffusion node, the dual conversion transistor configured to operate based on a dual conversion signal;
a reset transistor connected between a first power terminal and the second floating diffusion node, the reset transistor configured to operate based on a reset signal;
a drive transistor connected between a second power terminal and a first node, the drive transistor configured to operate based on a voltage of the first floating diffusion node; and
a select transistor connected between the first node and a column line, the select transistor configured to operate based on a selection signal.

20. The image sensor of claim 19, wherein, after transferring partial charges of the charges accumulated in the photodiode to the first floating diffusion node and before performing a first readout operation corresponding to the partial charges transferred to the first floating diffusion node, the image sensor is configured to transfer at least a part of remaining charges of the charges accumulated in the photodiode to the second floating diffusion node.
